(19) United States
(12) Patent Application Publication
(10) Pub. No.: US 2012/0301773 A1
(43) Pub. Date: Nov. 29, 2012

(54) ACCUMULATOR HAVING A DEVICE FOR CONDITIONING ACCUMULATOR CELLS

(75) Inventor: Stefan Roepke, Lassnitzhohe (AT)

(73) Assignee: MAGNA E-CAR SYSTEMS GmbH & CO. OG, Graz (AT)

(21) Appl. No.: 13/575,760

(22) PCT Filed: Jan. 28, 2011
(86) PCT No.: PCT/EP2011/051254

§ 371 Date: Jul. 27, 2012

(30) Foreign Application Priority Data
Jan. 28, 2010 (US) 61299249

(51) Int. Cl. H01M 10/50

(52) U.S. Cl. 429/120

(57) ABSTRACT

An accumulator having a housing, a plurality of voltage-generating cells that are arranged in the housing, a cooling/heating device and heat-conducting devices that are arranged between the cells and thermally coupled/connected to the cooling/heating device. In addition, at least one section of the housing is embodied as a cooling/heating device.

### CROSS-REFERENCE TO RELATED APPLICATIONS

The present application is a National Stage Application of PCT International Application No. PCT/EP2011/051254 (filed on Jan. 28, 2011), under 35 U.S.C. §371, which claims priority to U.S. Provisional Patent Application No. 61/299,249 (filed on Jan. 28, 2010), which are each hereby incorporated by reference in their respective entireties.

### FIELD OF THE INVENTION

The invention relates to an accumulator comprising a housing, a plurality of voltage-generating cells that are arranged in the housing, a cooling/heating device and heat-conducting devices that are arranged between the cells and are thermally coupled/connected to the cooling/heating device.

### BACKGROUND OF THE INVENTION

Accumulators are generally assembled from a plurality of voltage-generating cells in order to be able to deliver a required voltage, a required current and/or a required capacity. Particularly in the case of comparatively high-capacity accumulators, as are often used for electric motor vehicles, several hundred cells are frequently mutually connected. Therefore, as the cells are charged and discharged, corresponding high levels of heat are generated and these need to be discharged from the accumulator in order to prevent the accumulator from overheating. Similarly, the addition of heat can also heat up an accumulator, even if this accumulator is to be operated at a low external temperature.

For example, German Patent Publication DE 198 29 293 A1 discloses for this purpose a cooling device that is communicatively connected by means of a connection line to an inner chamber of a hermetically sealed housing, in which housing are received in a hermetically sealed manner a plurality of battery cells. The cooling device and the inner chamber of the hermetically sealed housing are filled with a cooling medium that has a high boiling point. The cooling medium absorbs heat that is produced by the plurality of battery cells in the hermetically sealed housing, so that the cooling medium evaporates. The evaporated cooling medium moves upward in the direction towards the cooling device and is condensed in the cooling device. The condensed cooling medium then flows back around the battery cells as a result of its intrinsic weight. Accordingly, the battery cells are uniformly and effectively cooled, so that they do not experience any change or difference in temperature. In one variant, the battery housing is closed directly by the cooling device.

A disadvantage of this is that in order to provide efficient cooling of the cells, it is necessary to provide intermediate spaces between the cells, in which intermediate spaces the cooling medium can circulate. Therefore, the battery produced has a relatively large volume in relation to its capacity.

In addition, there are a series of solutions, in which voltage-generating cells that are embodied as flat cells are arranged substantially at right angles to a cooling device. In so doing, protrusions of the cell housing are frequently folded over at right angles in order to provide a sufficiently large surface area for an acceptable amount of heat transfer between the cells and a cooling device. Alternatively, heat-conducting metal plates can also be arranged between the cells, which heat-conducting metal plates are folded over in the edge region and ensure in this manner a sufficient amount of heat transfer. This combination comprising the cells and the cooling device and/or the optional heat-conducting metal plates is then installed in a housing. Such arrangements are disclosed by way of example in German Patent Publication DE 10 2007 063 179 A1, German Patent Publication DE 10 2008 016 936 A1, German Patent Publication DE 10 2008 034 862 A1, German Patent Publication DE 102008034367 A1 and WO 2006/135008 A1.

There is also the disadvantage here that the accumulator produced has a relatively large volume, since not only the voltage-generating cells themselves are arranged in the battery housing, but also a cooling device provided for the cells is arranged therein. Moreover, the weight of the accumulator is increased by virtue of the cooling device that is arranged additionally in the housing. Finally, the condensation water that is formed on the cooler must be discharged out of the housing through a separate device.

### SUMMARY OF THE INVENTION

An object of the invention is, therefore, to provide an improved accumulator, in particular one that has a reduced volume or a reduced weight in relation to its capacity.

The invention is achieved by virtue of an accumulator of the type mentioned in the introduction, in which at least one section of the housing is embodied as a cooling/heating device.

In accordance with the invention, an equally light and small accumulator is produced in this manner, since the heat-conducting devices arranged between the cells ensure a sufficient discharge or supply of heat despite its compact dimensions. However, the accumulator in accordance with the invention is also simultaneously light in weight since the cooling/heating device is used not only to condition the cells but it also forms part of the battery housing. The cooling/heating device therefore fulfills a dual purpose. In addition, condensation water that is formed during the cooling operation, possibly on the outer face of the cooling/heating device, can simply run off on the housing outer face and it is not necessary to discharge the condensation water from the housing by means of devices specially provided for the discharging purpose.

The accumulator in accordance with the invention is therefore particularly suitable for mobile usage, for example in the automotive industry, where a comparatively small installation size and comparatively small weight play a central role. The usage is naturally not limited to the automotive industry. On the contrary, the accumulator can also be used in the shipbuilding industry and also in the aviation industry. However, the accumulator in accordance with the invention can naturally also be used in stationary operation.

Within the scope of the invention, the term “housing of the accumulator” is understood to mean a device that encompasses at least the voltage-generating cells. Advantageously, the cells are encompassed on all sides, however, it is also feasible to provide a housing in the form of a box that is open towards the top. Consequently, the housing forms at least in sections the outer delimitation of the accumulator.

In addition, within the scope of the invention, the term “thermal coupling” is understood to mean an arrangement of components, in this case specifically an arrangement of heat-conducting devices and a cooling/heating device, that renders it possible to transfer heat in a purposeful and/or targeted manner. In particular, the components involved can be in mutual contact for this purpose. However, in accordance with the invention, the term “thermal coupling” is not necessarily understood to mean a best possible heat transfer, i.e., a lowest possible heat resistance, between the components involved. It is also feasible, that purposeful thermal resistors are installed in the heat path in order to achieve different temperature levels between the components, and accordingly more or less constant temperature levels inside the components (having comparatively low thermal resistance).

Advantageous embodiments and developments of invention are now disclosed in the subordinate claims and the description with reference to the figures.

It is of advantage if the heat-conducting devices are folded over in the region of the cooling/heating device. In this manner, the heat transfer between the heat-conducting devices and the cooling/heating device can be improved on the basis of the enlarged contact surface.

It is of advantage if the heat-conducting devices protrude vertically beyond the cells in the region of the fold. In the case of this variant, the heat-conducting devices can, in addition to fulfilling their heat-conducting function, also be used to align the cells with respect to each other in the housing. For this purpose, the part of the heat conductive devices that protrudes beyond the cells is inserted in guide rails in the accumulator housing.

It is also of advantage if the heat-conducting devices protrude horizontally beyond the cells in the region of the fold. In this manner, the contact surface can be embodied in a relatively large manner with respect to the cooling/heating device if a heat-conducting device is provided, for example, only in the case of each second cell.

It is also of advantage if a heat-conducting device is adhered to at least one cell. In this manner, prefabricated units can be produced, which are then inserted or placed in position as desired in a housing and assembled to form an accumulator. In addition, the mechanical stability of the accumulator is also improved.

An accumulator in accordance with the invention is also of advantage if the accumulator comprises a pressure plate that is provided for the purpose of pressing the cells and the heat-conducting devices one against the other. As a consequence, heat is efficiently transferred between the cells and the heat-conducting devices even if the cells and the heat-conducting devices are not mutually connected (e.g. adhered or welded one to the other). In addition, it is also prevented that an existing connection is released and accordingly the cells and heat-conducting devices are prevented front falling around in the housing if high acceleration forces are exerted on the accumulator.

A particularly advantageous variant of an accumulator in accordance with the invention is provided if the accumulator comprises a cover plate that is provided for placing onto the cells and if the cover plate comprises on one side facing the cells ribs that are tapered and in particular wedge-shaped. In the case of this variant, a cover plate is placed on the packet that is formed from the cells and heat-conducting devices, which cover plate by virtue of the wedge-shaped ribs on the one hand positions the cells and accordingly the heat-conducting devices with respect to each other and on the other hand the cover plate optionally comprises a retaining device for an electronic circuit, for example a cell connector board. In addition, the housing is also closed or at least substantially closed towards the top by means of these cover plates.

It is of particular advantage if the cover plate tapers, in particular is wedge-shaped, on a side facing the heat-conducting devices. In this manner, the cover plate also fulfills a further function, namely it presses the heat-conducting devices against the housing, which on the one hand has a mechanical stabilizing effect on the accumulator but as a consequence, despite measurement tolerances of the components of the accumulator, also ensures an efficient heat transfer to the cooling/heating device as soon as the cover plate is placed on the housing.

Reference is made at this point to the fact that in particular the two latter mentioned embodiments, i.e., the variants of the cover plate, can form the basis for an independent invention.

It is also of advantage if a thermally and/or electrically insulating layer (for example a synthetic material layer) is provided between the heat-conducting devices and the cooling/heating device. In the case of this variant of the invention, the heat-conducting devices therefore do not lie directly on the cooling/heating device but rather an intermediate layer is provided, which intermediate layer insulates the parts in an electrical and/or thermal manner with respect to each other. The electrical insulation ensures that no dangerous electrical voltage occurs at the cooling/heating device. It is therefore not necessary to provide separate electrical insulation of the cooling/heating device. The thermal insulation ensures that there are no drastic drops in temperature inside the heat-conducting devices and inside the cooling/heating device.

Any possible existing difference in temperature substantially reduces at the insulating layer, similar to the manner in which the electrical voltage in a thermal equivalent circuit drops at the comparatively high resistance of the thermal insulation. Finally, it is further clarified that an electrical insulation is not mandatory—even when using a thermal insulation. On the contrary, the parts can also be mutually connected in an electrically conductive manner.

It is advantageous if the heat-conducting devices are inserted in the region of the cooling/heating device into this. In the case of this variant of the invention, the cooling/heating device comprises for example slots, into which the heat-conducting devices are inserted. In this manner, an efficient heat transfer between the cooling/heating device and heat-conducting devices is achieved, possibly by virtue of the slots being of a sufficient depth, without the heat-conducting devices having to be folded over for this purpose in order to increase the size of the contact surface with respect to the cooling/heating device.

In addition, it is advantageous if the cells are thermally coupled/connected to the cooling/heating device. In this manner, the heat transfer between the cooling/heating device and the cells can be further improved since the heat transfer is performed not only indirectly by means of the heat-conducting devices but also directly.

It is also of particular advantage if the heat-conducting devices form at least in sections walls of the cells. In this manner, it is possible to save material and reduce weight as a heat-conducting device is not only used for conducting heat alone but is also provided as a cell wall and thus fulfills a dual purpose.

It is of further advantage if the cooling/heating device and the heat-conducting devices are embodied in one piece. In the case of this variant, it is particularly easy to assemble the accumulator in accordance with the invention since only relatively few components are to be connected.

It is advantageous if heat-conducting metal plates, heat-conducting networks, heat-conducting grilles or flexible heat-conducting plates are provided as heat-conducting devices. These are readily available elements so that the accumulator in accordance with the invention can be achieved in a comparatively simple manner.

Finally, it is advantageous if the cooling/heating device forms a side part and/or a cover and/or a base of the housing, in particular a complete side part and/or a complete cover and/or a complete base. It is then of advantage that no additional or only a comparatively few additional components are required to provide the lateral, upper and/or lower delimitation of the housing. The advantages that have already been mentioned relating to weight-saving, efficient cooling/heating effect and the efficient discharge of condensation water are particularly clearly developed in the case of this variant of the invention and the advantages increase with the proportion of the surface created by the cooling/heating device.

The term a “complete” side part, cover and/or base is understood to mean in this context a component (i.e. a cooling/heating device) that forms the lateral, upper and/or lower delimitation of the housing with respect to the whole or at least with respect to a substantial part (e.g., 90% of the relevant surface). Naturally, other components, for example a frame, can also overlap the cooling/heating device inside and/or outside.

The above embodiments and developments of the invention can be combined in any manner as desired.

### BRIEF DESCRIPTION OF THE DRAWINGS

The present invention is explained in further detail hereinafter with reference to exemplary embodiments illustrated in the schematic figures of the drawing, in which:

FIG. 1 illustrates an oblique view of a unit formed from two accumulator cells and a heat-conducting metal plate.

FIG. 2 illustrates in a plan view the unit of FIG. 1.

FIG. 3 illustrates an oblique view an accumulator housing having a plurality of inserted accumulator cells installed and heat-conducting metal plates.

FIG. 4 illustrates the accumulator housing of FIG. 3 with an additionally mounted pressure plate.

FIG. 5 illustrates the accumulator housing of FIG. 4 with an additionally mounted cover plate.

FIG. 6 illustrates a detailed view of the accumulator housing of FIG. 5.

FIG. 7 illustrates a detailed view of a cover plate.

FIG. 8 illustrates a cross-sectional view through the accumulator in accordance with FIG. 5.

FIG. 9 illustrates the accumulator housing of FIG. 5 with a mounted cooling/heating device.

FIG. 10 illustrates the accumulator of FIG. 8 with an additionally mounted cooling/heating device.

### DETAILED DESCRIPTION OF EMBODIMENTS

It is mentioned in the introduction that like and similar parts in the figures are designated by like reference numerals and functionally similar elements and features, unless embodied differently, are designated by like reference-numerals but different indices.

It is further mentioned that positions described as “top,” “bottom,” “side,” “horizontal,” “vertical” and the like relate to the illustrated position of the accumulator and accordingly to a normal position in which the accumulator is used. If the position of the accumulator is changed, then the information relating to position is to be accordingly appropriately amended.

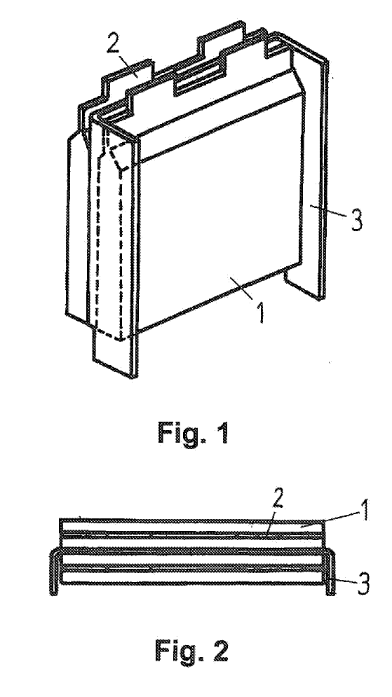

FIGS. 1 and 2 illustrate an arrangement comprising two cells 1, which have cell connections 2, and a heat-conducting metal plate 3 that is arranged between them and is provided as a heat-conducting device. FIG. 1 illustrates an oblique view of the arrangement while FIG. 2 illustrates a plan view. The heat-conducting metal plate 3 is folded over at both sides at 90° in this example, so that it can be easily coupled on both sides to a cooling/heating device once installed in a housing. Although this is advantageous, it is not mandatory. It is also possible that the heat-conducting metal plate 3 is also folded over only on one side, for example, only on the left or right, or also on three sides, i.e., is provided with an additional fold on the lower side.

In the example illustrated, the fold protrudes almost beyond the front cell 1, so that as much as possible of the surface is available for coupling to a cooling/heating device. The protruding ends of the heat-conducting metal plate 3 are of no hindrance when stacking a plurality of these units since the heat-conducting metal plate 3 encompasses only the rear cell 1 of the next unit in front. Therefore, when stacking the illustrated units, heat-conducting metal plate 3 is positioned after each second cell 1. However, it is also feasible that a heat-conducting metal plate 3 is provided after each cell 1, but the fold does not then protrude beyond the cell 1.

The heat-conducting metal plate 3 can be adhered to the cells 1 or otherwise connected thereto. It is also feasible that the cells 1 and the heat-conducting metal plate 3 are only loosely stacked one adjacent to the other and they are then pressed one against the other in the housing of a special device (cf. also FIG. 4). For the purpose of an optimum heat transfer between the cell 1 and the heat-conducting metal plate 3, it is also possible to apply a heat-conducting paste to the cell 1 and/or to the heat-conducting metal plate 3.

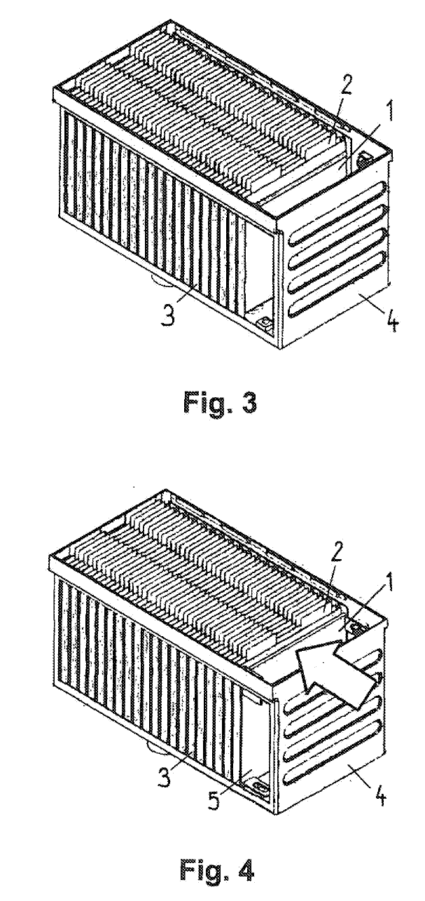

It is also clearly evident in FIG. 1 that the heat-conducting plate 3 also protrudes downwards beyond the cells 1. It is possible in this manner to insert it, for example, in rails that are provided in the housing of the accumulator (cf. also FIG. 3). Consequently, the cells 1 and the heat-conducting metal plate 3 are positioned in an optimum manner in the housing.

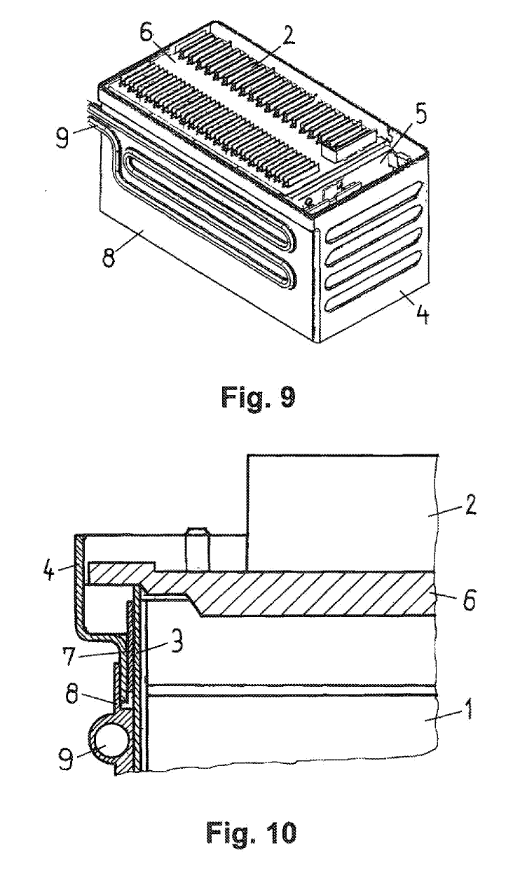

FIG. 3 now illustrates a housing 4 in which a plurality of units illustrated in FIGS. 1 and 2 are inserted, the heat-conducting metal plates 3 being inserted in laterally arranged rails. It is clearly evident that the cell connections 2 are all arranged aligned in the upward direction, so that they can be easily mutually connected, for example, with the aid of a cell connector board, in short CCB. In addition, it is clearly evident that not only the upper side of the housing 3 but also the two side walls of the housing 3 comprise orifices over the entire length of the housing 3. These lateral openings are subsequently closed by a cooling/heating device (cf. also FIG. 9).

FIG. 4 now illustrates how the cells 1 and the heat-conducting metal plate 3 are pressed one against the other. For this purpose, a pressure plate 5 is inserted and screwed into the housing 4. In this manner, the accumulators can be easily adapted to suit the respective application, in that sometimes more or sometimes fewer cells 1 are inserted into the housing 4. The arrow in FIG. 4 symbolizes the direction of the pressure that is applied by the pressure plate 5.

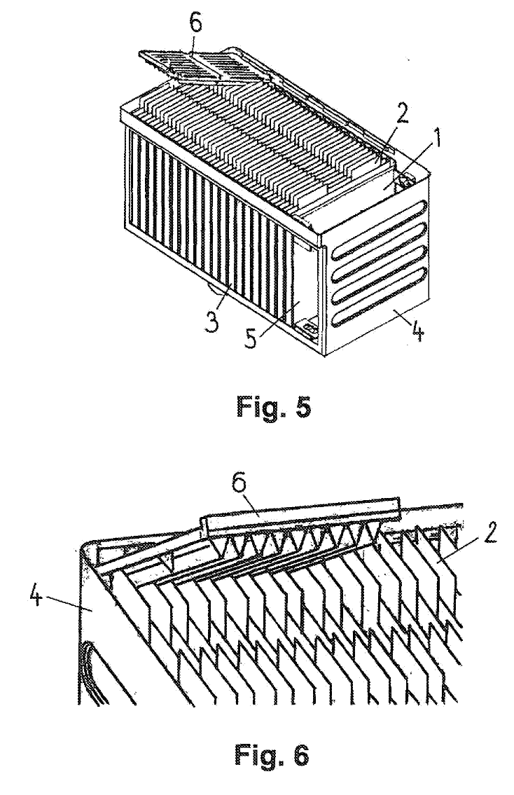

FIGS. 5 and 6 now illustrate how the cells 1 can also be aligned one against the other on their upper side. FIG. 5 illustrates an oblique overview while FIG. 6 illustrates an oblique detailed view. For this purpose, a cover plate 6 is placed on the cell stack. Wedge-shaped ribs on the lower side of the cover plate 6 ensure the cells 1 are aligned correctly. In addition, the cover plate 6 comprises slots, through which the cell connectors 2 protrude once the cover plate 6 has been placed in position.

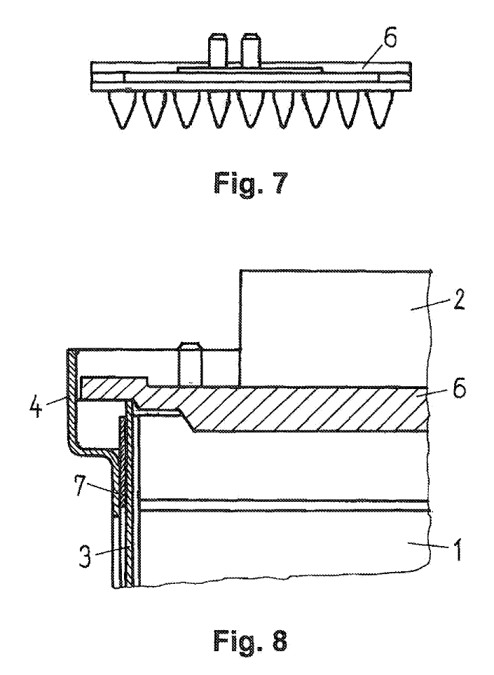

FIG. 7 illustrates a cover plate 6 in detail. Wedge-shaped ribs are evident on the lower side of the cover plate 6. Pin-shaped protrusions are also clearly evident on the upper side of the cover plate 6 and the cell connector board is subsequently placed on the pin-shaped protrusions (in this configuration the cover plate 6 can also be regarded in an expedient-manner as a carrier plate). The pins can also protrude through the cutouts in the cell connector board, whereby the cell connector board can be easily fixed on the cover plate 6 by mounting the cell connector board on spring disks. In order to ensure that the cell connector board is at the correct spaced disposition with respect to the cover plate 6, the pins can also be offset.

The thickness of the prismatic cells 1 varies in the range of +/−3%. If a cell stack is to be assembled with a plurality of cells 1, a tolerance range of several millimeters is produced and this is to be taken into consideration when attaching the cells 1, when making the electrical connection etc. The cover plates 6 and the cell connector plate are advantageously mounted in such a manner that the middle of the cell connector plate is positioned over the middle of the cell packet. Consequently, any positional deviations of the cell contacts with respect to their connections on the cell connector plate can be kept to a minimum.

Under certain circumstances, in particular if a large number of cells 1 are assembled to form an accumulator, it can be difficult to guide all the connections 2 through a single cover plate 6 in one procedure. For this reason, it can be of advantage if a plurality of cover plates 6 are provided for each accumulator, so that in each case only the connections 2 of a part of the cells 1 (e.g., 5 to 15 cells) that are assembled in an accumulator need to be guided through a cover plate 6 simultaneously.

FIG. 8 illustrates a cross-sectional view through the accumulator at the top level of a cell 1. In so doing, the cell 1 is clearly evident in the front view and the heat-conducting metal plate 3, to be more precise its folds, is/are clearly evident in the cross-sectional view. The cover plate 6 has already been mounted in the illustrated view. It is evident in FIG. 8 that the cover plate 6 not only aligns the cells 1 with respect to each other with the aid of the wedge-shaped ribs, but the cover plate also presses the heat-conducting metal plate 3 against the housing 4.

The cover plate 6 thus fulfills a multi-purpose function, it aligns the cells 1 with respect to each other, presses the heat-conducting metal plate 3 against the housing 4, closes the housing 4 towards the top and finally, together with its pins that are arranged at the top, acts as a retaining device for a cell connector board (not illustrated). In the present example, an intermediate plate 7 is provided between the heat-conducting metal plates 3 and the housing 4, which intermediate plate comprises, for example, an elastic material and thus ensures that there is a certain length compensation and accordingly compensation of the component tolerances.

FIG. 9 illustrates the accumulator in a further assembly step, in which the housing 4 is closed laterally by two side walls 8 that simultaneously form a cooling/heating device. A duct 9 for a heat transfer medium is provided on the side wall 8 and the heat transfer medium is guided in loops over the side wall 8. A fluid or gaseous heat carrier medium can flow through this duct 9 or, if the cooling/heating device is embodied as a cooling medium evaporator, it can also evaporate therein. The cooling medium connection of the cooling/heating device is located by virtue of this type of assembly outside the housing 4, so that there is no through-going site for a cooling medium pipe through the housing 4, which through-going site would otherwise require sealing. As a result of the cooling/heating device performing the dual-function as a housing cover, there is no requirement for a housing wall, as a consequence of which there is a saving in the amount of material and installation space required. In addition, it is not necessary for the condensation water that is possibly formed on the outer face of the cooling/heating device during the cooling operation to be discharged from the housing 4, on the contrary it can simply run off down the outer face of the housing.

Finally, FIG. 10 illustrates a cross-sectional view as illustrated in FIG. 8 through the accumulator but with an assembled side wall 8. The duct 9 is also clearly evident in the illustrated example, the thermal coupling is produced between the heat conducting metal plates 3 and the side wall 8, which forms/comprises a cooling/heating device by virtue of the physical contact between the two components. In order to improve the heat transfer, it is also possible to apply a heat-conducting paste between the heat-conducting metal plates 3 and the side wall 8. It is also feasible to provide an insulating plate between the heat-conducting metal plates 3 and the side wall 8, which insulating plate provides electrical insulation. In this manner, a dangerous electrical voltage can be prevented from occurring at the side 8. It is therefore not necessary to provide separate electrical insulation of the side wall 8. The insulating plate can in addition or as an alternative also provide thermal insulation. The thermal insulation ensures that there are no drastic drops in temperature inside the heat-conducting metal plates 3 and inside the cooling/heating device 8. Any possible existing difference in temperature substantially reduces at the insulating layer, similar to the manner in which the electrical voltage in a thermal equivalent circuit drops at the comparatively high resistance of the thermal insulation.

It is to be noted at this point that not only can the cooling/heating device 8 form a side part of the housing 4 as illustrated in FIGS. 9 and 10, but it can also form a cover or a base of the housing 4. Naturally, a plurality of side parts can also be embodied as the cooling/heating device 8. In addition, the cooling/heating device 8 can also be a combination of a side part and/or a base and/or a cover in order to enhance the cooling/heating effect.

Finally, reference is made to the fact that the illustrations in the FIGS. 1 to 10 have been simplified in parts. In reality, an accumulator in accordance with the invention can also deviate from the illustration; in particular it can comprise additional components not illustrated here. In conclusion, it is to be noted that the illustrations are not necessarily to scale and proportions of actual components can also deviate from the proportions of the illustrated components. It is also possible for the heat-conducting metal plates 3 illustrated in the figures to be effectively replaced by other heat-conducting devices, for example by heat-conducting networks, heat-conducting grilles or flexible heat-conducting plates.

1-17. (canceled)

18. An accumulator comprising:
a housing;
a plurality of voltage-generating cells in the housing;
a cooling/heating device; and
heat-conducting devices between the voltage-generating cells and thermally coupled to the cooling/heating device,
wherein at least one section of the housing comprises the cooling/heating device.

19. The accumulator of claim 18, wherein the heat-conducting devices are folded over in a region of the cooling/heating device.

20. The accumulator of claim 19, wherein the heat-conducting devices protrude vertically beyond the voltage-generating cells in the region of the fold.

21. The accumulator of claim 19, wherein the heat-conducting devices protrude horizontally beyond the voltage-generating cells in the region of the fold.

22. The accumulator of claim 18, wherein each heat-conducting device is adhered to at least one voltage-generating cell.

23. The accumulator of claim 18, further comprising a pressure plate configured to press each voltage-generating cell and each heat-conducting devices against each other.

24. The accumulator of claim 18, further comprising a cover plate provided on the voltage-generating cells.

25. The accumulator of claim 24, wherein the cover plate has tapered ribs on a side which faces the voltage-generating cells.

26. The accumulator of claim 25, wherein the cover plate tapers on a side facing the heat-conducting devices.

27. The accumulator of claim 18, further comprising a thermally insulating layer between the heat-conducting devices and the cooling/heating device.

28. The accumulator of claim 18, further comprising an electrically insulating layer between the heat-conducting devices and the cooling/heating device.

29. The accumulator of claim 18, wherein the heat conducting devices are provided in a region of the cooling/heating device.

30. The accumulator of claim 18, wherein the voltage-generating cells are thermally coupled to the cooling/heating device.

31. The accumulator of claim 18, wherein the heat-conducting devices form at least in sections walls of the voltage-generating cells.

32. The accumulator of claim 18, wherein the cooling/heating device and the heat-conducting devices are combined as a single component.

33. The accumulator of claim 18, wherein the heat-conducting devices comprises at least one of heat-conducting metal plates, heat-conducting networks, heat-conducting grilles and flexible heat-conducting plates.

34. The accumulator of claim 18, wherein the cooling/heating device forms a side wall of the housing.

35. The accumulator of claim 18, wherein the cooling/heating device forms a cover of the housing.

36. The accumulator of claim 18, wherein the cooling/heating device forms a base of the housing.

37. An accumulator comprising:
a housing having at least one section thereof comprising a cooling/heating device;
voltage-generating cells in the housing; and
a heat-conducting device between adjacent voltage-generating cells, and thermally coupled to the cooling/heating device.
